(19) United States
(12) Patent Application Publication
(10) Pub. No.: US 2016/0314469 A1
(43) Pub. Date: Oct. 27, 2016

(54) METHOD FOR GENERATING OFF-LINE AUTHENTICATION CREDENTIALS BY INTELLIGENT CARD

(71) Applicant: FEITIAN TECHNOLOGIES CO., LTD., Beijing (CN)

(72) Inventors: Zhou LU, Beijing (CN); Huazhang Yu, Beijing (CN)

(21) Appl. No.: 15/027,457

(22) PCT Filed: Dec. 8, 2014
(86) PCT No.: PCT/CN2014/093244

§ 371 Date: Apr. 6, 2016

(30) Foreign Application Priority Data
Dec. 31, 2013 (CN) 201310750552.X

(51) Int. Cl. G06Q 20/40; G06Q 20/38; H04L 29/06; G06Q 20/34

(52) U.S. Cl. CPC G06Q 20/4014; G06Q 20/34; G06Q 20/3829; H04L 63/0442; H04L 63/0435; H04L 63/0823; H04L 63/0853; G06Q 2220/00

(57) ABSTRACT

A method for generating off-line authentication credentials by an intelligent card. The method comprises: the card receiving a command sent by a terminal, determining the type of the command, and if the command is a Get Processing Option command, processing the command to obtain a second credential and returning the second credential to the terminal; if the command is an internal authentication command, processing the command to obtain a third credential and returning the third credential to the terminal; if the command is an application cryptogram command, first determining the type of the command, and if the command is a first application cryptogram command, processing the command to obtain a corresponding credential and returning the corresponding credential to the terminal; and if the command is a second application cryptogram command, processing the command to obtain a corresponding credential and returning the corresponding credential to the terminal. By means of the present invention, dynamic data can participate in authentication of the intelligent card, the card is prevented from being copied on the basis that static data is not tampered, and use security of the intelligent card is improved.

### FIELD OF THE INVENTION

The present invention relates to a method for generating a credential of offline authentication by a smart card, which belongs to the field of smart card technology.

### PRIOR ART

With the popularity of the smart card, there often happen cases, in which a smart card is interpolated or copied; thus, the security of smart card information is paid more attention to. In prior art, in a common process of offline operation, whether static information of a card is interpolated is determined via a public key certificate, static data and a hash value. Although the technical solution above can prevent the static data from being interpolated maliciously, it cannot prevent information from being stolen or prevent a card from being copied, either.

### SUMMARY OF THE INVENTION

The object of the present invention is to provide a method for generating a credential of offline authentication by a smart card, in which dynamic data takes part in the process of smart card authentication so as to prevent the card from being copied on the basis of ensuring that the static data is not interpolated so as to make the smart card safer.

Thus, the present invention provides a method for generating a credential of offline authentication by a smart card, which includes:

Step 101, powering on a smart card and initializing the card;

Step 102, waiting, by the card, for receiving a command sent by a terminal, and determining a type of the command;

in the case that the command is a command for getting processing options, parsing the command for getting processing options so as to obtain a first data, updating a first card data, and initializing a second card data and a third card data, generating a second credential according to a type of offline authentication which is supported by the card, and then returning the second credential to the terminal, and returning to Step 102;

in the case that the command is an internal authentication command, determining whether the internal authentication command supports a dynamic data authentication, if yes, parsing the internal authentication command so as to obtain a second data, obtaining a first combinatorial data according to the second data and the first card data, signing the first combinatorial data by using a card private key so as to obtain dynamic signature data, then generating a third credential according to the dynamic signature data, and returning the third credential to the terminal, and then returning to Step 102; otherwise, returning an error response to the terminal, and returning to Step 102;

in the case that the command is an application cryptogram command, determining a type of application cryptogram command, executing Step 103 if the application cryptogram command is the first application cryptogram command; executing Step 108 if the application cryptogram command is the second application cryptogram command;

Step 103, determining, by the card, whether the first data can be obtained, if yes, executing Step 104; otherwise, returning an error response to the terminal, and returning to Step 102;

Step 104, obtaining, by the card, a type of application cryptogram which is requested by the terminal from the first application cryptogram command, updating the second card data and the third card data by executing a card action analysis, subsequently, determining whether the card meets the type of application cryptogram requested by the terminal, if yes, generating a first application cryptogram according to a result of the card action analysis, and executing Step 105; otherwise, generating a second application cryptogram according to the result of the card action analysis, and executing Step 105;

Step 105, parsing, by the card, the first application cryptogram command, determining whether a composite and dynamic data authentication is needed, if yes, executing Step 106; otherwise, generating a fourth credential according to the first card data, the second card data, the third card data and the second application cryptogram, and returning the fourth credential to the terminal, returning to Step 102;

Step 106, obtaining, by the card, a third data from the first application cryptogram command, obtaining a fourth combinatorial data according to the first data, the first card data, the second card data, the third card data, the first application cryptogram and the third data, then signing the fourth combinatorial data by using the card private key so as to obtain a first signature data, subsequently, generating a fifth credential according to the first card data, the second card data, the third card data and the first signature data, and returning the fifth credential to the terminal, returning to Step 102;

Step 107, determining, by the card, whether the first data and the third data can be obtained, if yes, executing Step 108; otherwise, returning an error response to the terminal, and returning to Step 102;

Step 108, obtaining, by the card, a type of application cryptogram which is requested by the terminal from the second application cryptogram command, updating the second card data and the third card data by executing the card action analysis, and determining whether the card supports the type of application cryptogram requested by the terminal, if yes, generating a third application cryptogram according to the result of the card acting analysis, and executing Step 109; otherwise, generating a fourth application cryptogram according to the result of the card action analysis, and executing Step 109;

Step 109, parsing, by the card, the second application cryptogram command, determining whether the composite and dynamic data authentication is needed, if yes, executing Step 110; otherwise, generating a sixth credential according to the first card data, the second card data, the third card data and the fourth application cryptogram, and returning the sixth credential to the terminal, and returning to Step 102; and

Step 110, obtaining, by the card, a fourth data from the second application cryptogram command, obtaining a seventh combinatorial data according to the first data, the first card data, the second card data, the third card data, the third application cryptogram, the third data and the fourth data; signing the seventh combinatorial data by the card private key so as to obtain a second signature data, and then generating a seventh credential according to the first card data, the second card data, the third card data and the second signature data, returning the seventh credential to the terminal, and returning to Step 102.

Preferably, when the received command is a selecting application command, Step 102 further includes the follow steps:

Step 102-1, parsing, by the card, the selecting application command, determining a selection mode in the selecting application command according to a data field of the selecting application command, executing Step 102-2 in the case that the selection mode is a first selection mode; executing Step 102-3 in the case that the selection mode is a second selection mode;

Step 102-2, obtaining, by the card, a first application information from the selecting application command, retrieving the card according to the first application information, subsequently, determining whether an application file which corresponds to the first application information can be found, if yes, making the application file corresponding to the first application information as a current application file, and executing Step 102-4; otherwise, returning a response that the first application information is not supportive, and returning to Step 102;

Step 102-3, obtaining, by the card, a second application information from the selecting application command, retrieving the card according to the second application information, subsequently, determining whether an application file corresponding to the second application information can be found, if yes, making the application file corresponding to the second application information as a current application file, and executing Step 102-4; otherwise, returning the response that the second application information is not supportive to the terminal, and returning to Step 102;

Step 102-4, obtaining, by the card, a first list from the current application file, generating a first credential according to the first list, returning the first credential to the terminal, and returning to Step 102.

Preferably, Step 102-2 specifically includes:

Step 102-21, obtaining, by the card, a status of the card, and determining whether the card is locked, if yes, returning a response that the card is locked to the terminal, and returning to Step 102; otherwise, executing Step 102-22;

Step 102-22, obtaining, by the card, the first application information from the selecting application command, retrieving the card according to the first application information, and determining whether application information corresponding to the first application information is retrieved, if yes, executing Step 102-23; otherwise, returning the response that the first application information is not supportive to the terminal, and returning to Step 102; and

Step 102-23, determining, by the card, whether the first application information is locked, if yes, returning a response that the first application information is locked to the terminal, and returning to Step 102; otherwise, making the application file corresponding to the first application information as the current application file, and returning to Step 102-4.

Preferably, Step 102-3 specifically includes:

Step 102-31, obtaining, by the card, the status of the card, and determining whether the card is locked, if yes, returning the response that the card is locked to the terminal, and returning to Step 102; otherwise, executing Step 102-32;

Step 102-32, obtaining, by the card, the second application information from the selecting application command, subsequently, retrieving the card according to the second application information, and determining whether the application file corresponding to the second application information is retrieved, if yes, executing Step 102-23; otherwise, returning the response that the second application information is not supportive to the terminal, and returning to Step 102; and

Step 102-33, determining, by the card, whether the second application information is locked, if yes, returning the response that the second application information is locked to the terminal, and returning to Step 102; otherwise, making the application file corresponding to the second application information as the current application file, and executing Step 102-4.

Preferably, in the case that the command is a command for getting processing options, Step 102 specifically includes:

Step a1, determining, by the card, whether the first data can be obtained by parsing the command for getting processing options, if yes, saving the first data, and executing Step a2; otherwise, returning error information to the terminal, and returning to Step 102;

Step a2, updating, by the card, the first card data, checking whether the first card data reaches a threshold, if yes, executing Step a3; otherwise, executing Step a4;

Step a3, generating the response that the card is locked in the case that the card is locked, and returning the response to the terminal, then returning to Step 102;

Step a4, initializing, by the card, the second card data and the third card data; and

Step a5, obtaining, by the card, file information which is to be read inside the card, and then obtaining first information according to the file information, generating the second credential according to the first information and the type of offline authentication supported by the card, and returning the second credential to the terminal, and returning to Step 102.

Preferably, in the case that the received command is a read record command, Step 102 further includes:

Step f1, parsing, by the card, the read record command so as to obtain the first information; and

Step f2, reading, by the card, application data from the card according to the first information, returning the application data to the terminal, and returning to Step 102.

Preferably, in the case that the command is an internal authentication command and the command supports the dynamic data authentication, Step 102 further includes: setting, by the card, an executable bit of the dynamic data authentication.

Preferably, in Step 102, determining the type of application cryptogram command specifically is: parsing, by the card, the application cryptogram command, determining the type of application cryptogram command according to a flag in the application cryptogram command, the application cryptogram command is the first application cryptogram command in the case that the flag in the application cryptogram command is a first preset value; the application cryptogram command is the second application cryptogram command in the case that the flag in the application cryptogram command is a second preset value.

Preferably, between Step 103 and Step 104, the method further includes: determining, by the card, whether static data is authenticated successfully according to a first flag of the first application cryptogram command, if yes, executing Step 104; otherwise, returning a response of refusing operation to the terminal, and returning to Step 102;

in which, determining whether the static data is authenticated successfully specifically includes: determining whether the first flag is a third preset value, if yes, the static data is authenticated successfully; otherwise, the static data is authenticated unsuccessfully, and returning the response that refuse to operate.

Preferably, in Step 105, determining whether the composite and dynamic data authentication is needed specifically comprises: determining, by the card, whether a second flag of the first application cryptogram command is a fourth preset value, if yes, executing the composite and dynamic data authentication; otherwise, the composite and dynamic data authentication is not needed.

Preferably, in Step 104, obtaining the type of application cryptogram which is requested by the terminal from the first application cryptogram command specifically including: obtaining, by the card, the type of application cryptogram which is requested by the terminal according to a third flag of the first application cryptogram command, the type of application cryptogram which is requested by the terminal is refusing execution offline in the case that the third flag is a fifth preset value; the type of application cryptogram requested by the terminal is online executing in the case that the third flag is a sixth preset value; the type of application cryptogram requested by the terminal is approving execution offline in the case that the third flag is a seventh preset value.

Preferably, generating the first application cryptogram specifically includes:

Step b1, obtaining, by the card, terminal data from the first application cryptogram command, and combining the terminal data, the second card data and the third card data so as to obtain data which generates the application cryptogram;

Step b2, pre-grouping, by the card, the data which generates the application cryptogram, determining whether a length of a last data block after the data is grouped is a first preset length, if yes, executing Step b3; otherwise, executing Step b4;

Step b3, adding, by the card, a preset data block to the last data block, making data which is added with the preset data block as new data which generates the application cryptogram, and executing Step b5;

Step b4, filling, by the card, one byte of a first preset data behind the last data block, determining whether a length of the filled data block is the first preset length, if yes, making the filled data as new data which generates the application cryptogram, and executing Step b5; otherwise, filling a second preset data behind the first preset data, then continuing the same operation until the length of the last data block is the preset length, so as to obtain new data which generates the application cryptogram, and executing Step b5; and

Step b5, obtaining, by the card, an application process key corresponding to the current application file, calculating the new data which generates the application cryptogram via a symmetric-key algorithm so as to generate the first application cryptogram.

Preferably, in Step 106, obtaining the fourth combinatorial data according to the first data, the first card data, the second card data, the third card data, the first application cryptogram and the third data specifically includes:

Step 106-1, obtaining, by the card, a second combinatorial data according to the first data, the third data, the first card data, the second card data and the third card data;

Step 106-2, obtaining, by the card, hash algorithm according to a hash algorithm identification of the first application cryptogram command, and operating hash calculation on the second combinatorial data so as to obtain a first hash value;

Step 106-3, obtaining, by the card, a third combinatorial data according to the first application cryptogram, the first hash value, the first card data and the third data;

Step 106-4, operating, by the card data, hash calculation on the third combinatorial data so as to obtain a second hash value; and

Step 106-5, obtaining, by the card, a fourth combinatorial data according to the first card data, the first application cryptogram, the first hash value and the second application cryptogram.

Preferably, Step 106-1 specifically is: jointing, by the card, the first data, the third data, the second card data, the first card data and the third card data orderly so as to obtain the second combinatorial data.

Preferably, Step 106-3 specifically is: obtaining, by the card, the number of bytes of a second preset length from the third data, jointing orderly the third preset data, the hash algorithm identification, the first card data, the first application cryptogram, the first hash value, a preset filled byte and the obtained number of bytes so as to obtain the third combinatorial data.

Preferably, Step 106-5 specifically is: jointing orderly a fourth preset data, the hash algorithm identification, the first card data, the first application cryptogram, the first hash value, the preset filled byte, the second hash value and a fifth preset data so as to obtain the fourth combinatorial data.

Preferably, between Step 107 and Step 108, the method further includes: determining, by the card, whether the static data is authenticated successfully according to a fourth flag of the second application cryptogram command, the static data is authenticated successfully in the case that the fourth flag is 0, and continuing the process; the static data is authenticated unsuccessfully in the case that the fourth flag is 1, returning the response that refusing to operate to the terminal, and returning to Step 102.

Preferably, when the composite and dynamic data authentication is needed, Step 109 further comprises: setting, by the card, the executable bit of the composite and dynamic data authentication.

Preferably, in Step 109, determining whether the composite and dynamic data authentication is needed specifically includes: determining, by the card, whether the composite and dynamic data authentication is needed according to a fifth flag of the second application cryptogram command, the composite and dynamic data authentication is needed in the case that the fifth flag is 1; the composite and dynamic data authentication is not needed in the case that the fifth flag is 0.

Preferably, in Step 108, obtaining the type of application cryptogram requested by the terminal from the second application cryptogram command specifically includes: obtaining, by the card, the type of application cryptogram requested by the terminal according to the fifth flag of the second application cryptogram command, the type of application cryptogram requested by the terminal is refusing execution offline in the case that the fifth flag is 00; the type of application cryptogram requested by the terminal is executing online in the case that the fifth flag is 01; the type of application cryptogram requested by the terminal is approving execution offline in the case that the fifth flag is 10.

Preferably, determining whether the card supports the type of application cryptogram requested by the terminal specifically includes:

Step c1, executing, by the card, the card action analysis, and detecting whether there exists an online authorization operation which is unfinished last time, if yes, returning an error response to the terminal, returning to Step 102; otherwise, executing Step c2;

Step c2, determining, by the card, whether an authentication by issuer in last operation fails, if yes, returning an error response to the terminal, and returning to Step 102; otherwise, executing Step c3;

Step c3, determining, by the card, whether an offline data authentication in last operation fails, if yes, returning an error response to the terminal, and returning to Step 102; otherwise, executing Step c4; and

Step c4, executing, by the card, a frequency checking, determining whether times of operation reach a limit, if yes, returning an error response to the terminal, and returning to Step 102; otherwise, the card support the type of application cryptogram requested by the terminal.

Preferably, generating the third application cryptogram specifically includes:

Step d1, obtaining, by the card, the terminal data from the second application cryptogram command, combining the terminal data, the second card data and the third card data so as to obtain the data which generates the cryptogram;

Step d2, pre-grouping, by the card, the data which generates the cryptogram, and determining whether the length of the last data block obtained after the data is pre-grouped is the first preset length, if yes, executing Step d3; otherwise, executing Step d4;

Step d3, adding, by the card, a preset data block to the last data block, and then making the data which is added with the preset data block as new data which generates a cryptogram, and executing Step d5;

Step d4, filling, by the card, one byte of the first preset data behind the last data block, determining whether a length of the data block obtained after the last data block is filled with one byte of the first preset data is the first preset length, if yes, making the filled data as new data which generates a cryptogram, and executing Step d5; otherwise, filling the second preset data behind the first preset data, and continuing the operation until the length of the last data block is the preset length so as to obtain the new data which generates the cryptogram, and executing Step d5; and

Step d5, obtaining, by the card, the application process key corresponding to the current application file, performing symmetric-key algorithm on the new data which generates the application cryptogram according to the application process key so as to generate a third application cryptogram.

Preferably, in Step 110, obtaining the seventh combinatorial data according to the first data, the first card data, the second card data, the third card data, the second application cryptogram, the third data and the fourth data specifically includes:

Step 110-1, obtaining, by the card, a fifth combinatorial data according to the first data, the third data, the first card data, the second card data, the third card data and the fourth data;

Step 110-2, obtaining, by the card, the hash algorithm according to the hash algorithm identification of the second application cryptogram command, performing hash calculation on the fifth combinatorial data so as to obtain a third hash value;

Step 110-3, obtaining, by the card, a sixth combinatorial data according to the second application cryptogram, the third hash value, the first card data and the fourth data;

Step 110-4, performing, by the card, hash calculation on the sixth combinatorial data so as to obtain a fourth hash value; and

Step 110-5, obtaining, by the card, the seventh combinatorial data according to the third hash value, the fourth hash value, the first card data, the second application cryptogram.

Preferably, Step 110-1 specifically includes: jointing orderly, by the card, the first data, the third data, the fourth data, the second card data, the first card data and the third card data so as to obtain the fifth combinatorial data.

Preferably, Step 110-3 specifically includes: obtaining, by the card, the number of bytes of the second preset length from the fourth data, jointing orderly the third preset data, the hash algorithm identification, the first card data, the second application cryptogram, the third hash value, the preset filled byte and the obtained number of bytes so as to obtain the sixth combinatorial data.

Preferably, Step 110-5 specifically includes: jointing orderly, by the card, the fourth preset data, the hash algorithm identification, the first card data, the second application cryptogram, the third hash value, the preset filled byte and the fifth preset data so as to obtain the seventh combinatorial data.

Preferably, updating the second card data and the third card data by executing the card action analysis specifically includes:

Step e1, setting, by the card, a first indicating bit of the second card data according to a result obtained by detecting the online authorization in the last operation;

Step e2, setting, by the card, a second indicating bit of the second card data and a first indicating bit of the third card data according to a result obtained by detecting the authentication of issuer in the last operation;

Step e3, setting, by the card, a third indicating bit of the second card data according to a result obtained by detecting the static data authentication in the last operation;

Step e4, detecting the dynamic data authentication in last operation so as to obtain a result, setting, by the card, a fourth indicating bit of the second card data; and

Step e5, setting, by the card, a fifth indicating bit of the second card data according to a result obtained by detecting process of issuer's script in last online authorization operation;

Preferably, in Step 102, obtaining the first data further includes: saving the first data;

in the Step 102, obtaining the second data further includes: saving the second data;

in the Step 102, after returning the third credential to the terminal, the method further includes: deleting the second data;

in Step 106, obtaining the third data from the first application cryptogram command further includes: saving the third data;

in Step 110, obtaining the fourth data from the second application cryptogram command further including: saving the fourth data;

in Step 110, returning the seventh credential to the terminal further includes: deleting the first data, the third data and the fourth data.

As an advantage of the present invention, dynamic data takes part in the process of smart card authentication so as to prevent a card from being copied on the basis of ensuring that the static data is not interpolated, in this way, the method makes a smart card safer.

### BRIEF DESCRIPTION OF THE DRAWINGS

The Embodiments of the present invention or technical solutions in the prior art are further described more clearly and completely with the drawings in the Embodiments of the present invention. Obviously, Embodiments described are just a few of all Embodiments of the present invention, when it comes to those skilled in the art, other drawings can be obtained by them without inventive work.

FIG. 1 shows a flow diagram illustrating a method for generating a credential of offline authentication by a smart card according to Embodiment 1 of the present invention;

FIG. 2 shows a detailed drawing of Step 119 in Embodiment 1 of the present invention; and

FIG. 3 shows a detailed drawing of Step 120 in Embodiment 1 of the present invention.

### EMBODIMENTS

The technical solution in the Embodiments of the present invention is further described more clearly and completely with the drawings in the Embodiments of the present invention. Apparently, Embodiments described are just a few of all Embodiments of the present invention. On the basis of Embodiments of the invention, all other related Embodiments made by those skilled in the art without inventive work belong to scope of protection of the invention.

### Embodiment 1

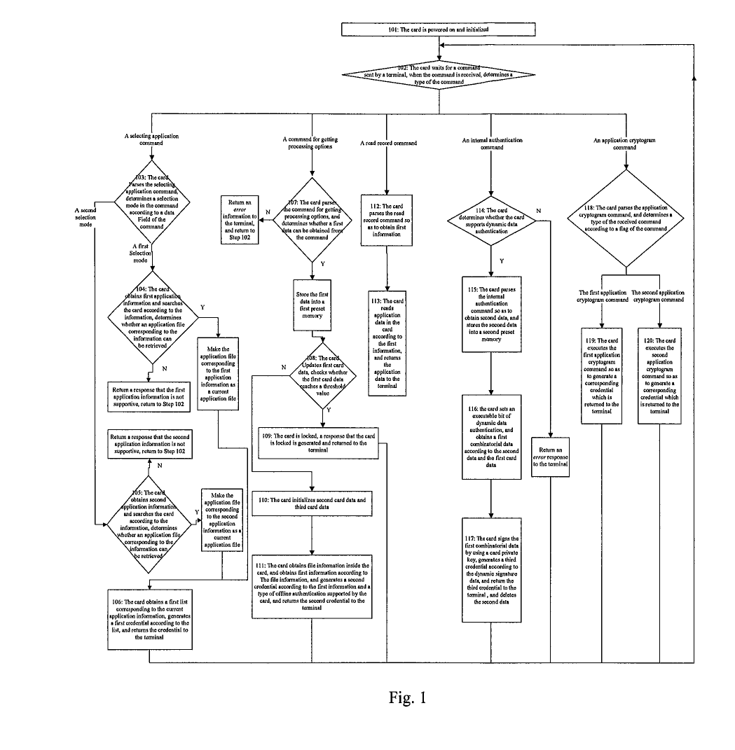

Embodiment 1 of the present invention provides a method for generating a credential of an offline authentication by a smart card, as shown in FIG. 1, the method comprises:

Step 101, a card is powered on and initialized;

Step 102, the card waits for receiving a command from a terminal, when the command is received, a type of the command is determined, execute Step 103 in the case that the command is a selecting application command; execute Step 107 in the case that the command is a command for getting processing options; execute Step 112 in the case that the command is a read record command; execute Step 114 in the case that the command is an internal authentication command; execute Step 118 in the case that the command is an application cryptogram command;

In Embodiment 1, preferably, when a second byte of the command parsed by the card is 0xA4, the received command is a selecting application command, Step 103 is executed; when the second byte of the command parsed by the card is 0xA8, the received command is a command for getting processing options, Step 107 is executed; when the second byte of the command parsed by the card is 0xB2, the received command is a read record command, Step 112 is executed; when the second byte of the command parsed by the card is 0x88, the received command is an internal authentication command, Step 114 is executed; when the second byte of the command parsed by the card is 0xAE, the received command is an application cryptogram command, Step 118 is executed;

Step 103, the card parses the selecting application command, and then determines a selection mode in the selecting application command according to a data field of the selecting application command, Step 104 is executed in the case that the selection mode is a first selection mode; Step 105 is executed in the case that the selection mode is a second selection mode;

in which, the first selection mode is a catalog selection mode, the second selection mode is an AID list selection mode;

In Embodiment 1, the card obtains the selection mode of the selecting application command according to the data field of the selecting application command;

Step 104, the card obtains first application information from the selecting application command, and determines whether an application file corresponding to the first application information can be retrieved, if yes, make the application file corresponding to the first application information as a current application file, and execute Step 102-4; otherwise, return a response that the first application information is not supportive to the terminal, and return to Step 102;

For example, the received selecting application command is 00A404000E315041592E5359532E4444463031,

the obtained data field is 000E315041592E5359532E4444463031, which is the first application information;

the retrieved application file is 6F15840E315041592E5359532E4444463031A503880101.

In Embodiment 1, Step 104 specifically comprises:

Step 104-1, the card obtains a status of the card, determines whether the card is locked, if yes, return a response that the card is locked to the terminal, and return to Step 102; otherwise, execute Step 104-2;

Step 104-2, the card obtains the first application information from the selecting application command, retrieves from the card according to the first application information, and determines whether an application file corresponding to the first application information can be retrieved, if yes, execute Step 104-3; otherwise, return a response that the first application information is not supportive to the terminal, and return to Step 102;

Step 104-3, the card determines whether the first application information is locked, if yes, return a response that the first application information is locked to the terminal, and return to Step 102; otherwise, make the application file corresponding to the first application information as the current application file, and execute Step 106.

Step 105, the card obtains second application information from the selecting application command, retrieves from the card according to the second application information, determines whether an application file corresponding to the second application information can be retrieved, if yes, make the application file corresponding to the second application information as the current application file, and execute Step 106; otherwise, return a response that the second application information is not supportive, and return to Step 102;

for example, the received selecting application command is 00A4040007A0000003330101,

the obtained data field is 0007A0000003330101, which is the second application information, the retrieved application file is 6F5B8407A0000003330101A550500B50424F43204372656469748701019F380F9F1A029F7A 019F02065F2A029F4E145F2D087A68656E667264659F1101019F120F4341524420494D41474 52030303330BF0C0A9F4D020B0ADF4D020C0A;

In Embodiment 1, Step 105 specifically includes:

Step 105-1, the card obtains the status of the card, determines whether the card is locked, if yes, return a response that the card is locked to the terminal, and return to Step 102; otherwise, execute Step 105-2;

Step 105-2, the card obtains the second application information of the selecting application command, retrieves from the card according to the second application information, determines whether an application file corresponding to the second application information can be retrieved, if yes, execute Step 105-3; otherwise, return the response that the second application information is not supportive to the terminal, and return to Step 102;

Step 105-3, the card determines whether the second application information is locked, if yes, return a response that the second application information is locked to the terminal, and return to Step 102; otherwise, make the application file corresponding to the second application information as the current application file, and execute Step 106.

In Embodiment 1, preferably, the terminal sends the selecting application command which includes the application information in Step 104 to the card, in the case that the card does not support the application information, the terminal sends the selecting application command which includes the application information in Step 105; when the card receives the selecting application command from the terminal, it determines whether the received selection mode which is requested by the terminal is supportive according to the data field.

Step 106, the card obtains a first list from the current application file, a first credential is generated according to the first list, the first credential is returned to the terminal, and Step 102 is returned to;

for instance, in the present Embodiment, the current application file is 6F15840E315041592E5359532E4444463031A503880101, thus, the obtained first list corresponding to the current application file is 9F380F9F1A029F7A019F02065F2A029F4E14;

the first credential generated by the card according to the first list is: 6F5B8407A0000003330101A550500B50424F43204372656469748701019F380F9F1A029F7A 019F02065F2A029F4E145F2D087A68656E667264659F1101019F120F4341524420494D41474 52030303330BF0C0A9F4D020B0ADF4D020C0A;

Step 107, the card parses the command for getting processing options, determines whether a first data can be parsed from the command for getting processing options, if yes, the first data is stored into a first preset memory, and Step 108 is executed; otherwise, an error response is returned to the terminal, and Step 102 is returned to;

In the present Embodiment, the command for getting processing options is 80A8000021831F015601000000000200015642616E6B204361726420546573742043656E7465;

In Embodiment 1, the first data which is parsed by the card from the command for getting processing options is 015601000000000200015642616E6B204361726420546573742043656E7465;

in which, the first data is the data which is obtained by organizing by the terminal according to the format of the first list in a first response;

Step 108, the card updates a first card data, checks whether the first card data reaches a preset threshold, if yes, execute Step 109; otherwise, execute Step 110;

In Embodiment 1, preferably, the preset threshold is 65535; updating the first card data specifically is that: the first card data plus 1;

Step 109, the card is locked, the response that the card is locked is generated, the response is returned to the terminal, and Step 102 is returned to;

Step 110, the card initializes a second card data and a third card data;

Step 111, the card obtains file information which is to be read inside the card, first information is obtained according to the file information, a second credential is generated according to the first information and a type of offline authentication which is supported by the card, and then the second credential is returned to the terminal, and Step 102 is returned to;

In Embodiment 1, that the first information is obtained according to the file information specifically includes: setting up the first information according to a short file identifier of the file, a record number of the file, the number of file records and a place for storing static signature data which is needed in the offline data authentication;

In Embodiment 1, preferably, when a type of offline authentication supported by the card is 7D00, the card supports a static data authentication and a dynamic data authentication, but the card does not support a composite and dynamic data authentication; when the type of offline authentication supported by the card is 5C00, the card supports a static data authentication, but the card does not support a dynamic data authentication or a composite and dynamic data authentication;

In Embodiment 1, the first information obtained by the card is 080102001001040118010400, the type of offline authentication supported by the card is 7D00, and the second credential generated according to the first information and the type of offline authentication supported by the card is 800E7D00080102001001040118010400;

Step 112, the card parses the read record command so as to obtain the first information;

Step 113, the card reads application data in the card according to the first information, subsequently, returns the application data in the card to the terminal, return to Step 102;

In Embodiment 1, the application data read by the card according to the first information includes CA public key index, signed static application data, a public key certificate of issuer and data used for card action analysis;

In Embodiment 1, the read record command is 00B201xx00, in which, 01 indicates the file record number, xx indicates the last record number recorded which is to be read, and the last record number of the read record command obtained according to the first information.

In Embodiment 1, the card reading the application data in the card according to the first information specifically comprises:

Step a1, the card pre-groups the first information so as to obtain the number of file records in the first information;

Preferably, pre-grouping the first information specifically includes: the first information is pre-grouped in line with that four bytes as a group; in Embodiment 1, the first information is pre-grouped into three groups which are 08010200, 10010401 and 18010400;

Step a2, the card obtains a first byte of each record successively, the five most significant bits of the first byte is jointed with preset data so as to obtain the last record number of the read record command; Preferably, the preset data is 100;

In Embodiment 1, the first group is 08010200, the obtained first byte is 08, the five most significant bits is 00001 which is jointed with 100, subsequently 00001100 which is 0x0C is obtained, thus, the first read record command sent by the terminal according to the first information is 00B2010000;

the second group is 10010401, the first byte of the second group is 10, the five most significant is 00010 which is jointed with 100, subsequently 00010100 which is 0x14 is obtained, thus, the second read record command sent by the terminal according to the first information is 00B2011400; and

the third group is 18010400, the first byte of the third group is 18, the five most significant is 00011 which is jointed with 100, subsequently, 00011100 which is 0x1C is obtained, thus the third read record command sent by the terminal according to the first information is 00B2011C00;

Step a3, the card reads the second byte and the third byte from each record successively, the number of records which need to be read is obtained according to the second byte and the third byte, and the records are read from the card, subsequently, all read records are composite so as to obtain the application data.

In Embodiment 1, in the case that the first group is 08010200, the second byte and the third byte are 0102, the first record and the second record are read from the location whose record number is 0x08;

the first record read by the card is 702E57136228000100001117D3012201012345123999919F1F163031303230333034303530363 0373038303930413042;

the second record read by the card is 70125F200F46554C4C2046554E4354494F4E414C;

in the case that the second group is 10010401, the second byte and the third byte are 0104, records from the first record to the fourth record are read from the location whose record number is 0x10;

the first record read by the card is 70165A0862280001000011175F24033012315F2503950701;

the second record is 7081849F468180875F85F08A89F4B500FA8C1A55407D88322710E3B885390D945422A73A0 AB876F4C4FBC9C49C3083F38C9EFE6C7B21F6541050BF11642A28329C65D8831C80CC0 D753D412112800FF2FA12ECC83B318A26EE44E313BD5D1C45C806787387DB91D2959D7 5D350F9CD18B34C635A94EF343A2E88F8A4162D83BC900EA2CF5592820;

the third record is 70619F47030100019F482A518B0EA3ABA9343F1778545FFB49EE840BBCEA457DBAABB FD755BA0F943A08A59CFFB6066B40847675999F0702FFC08E0A000000000000000001009F0D057C70B808009F0E057C70B808009F0F0500000000005F28020156;

the fourth record is 708183938180817B58E992D032B7F0C0B5E0AA146F53FDD20DE1B3BFD9BFD28D0D7B5 D4B69A62E1442847EC0FCED37C41A653AC8AEFF680704607E7D6EDBB683FDF8AE3CB A63FD2FB93845D9DA06F5B6CC09E807A0B69D5CF6FAFFDEC65A3E00C560947E4822F D74D0A4994493C9D5E92F83634C1EE77BC805F838A9A79E114787B65F6B74B9;

in the case that the third group is 18010400, the second byte and the third byte are 0104, records from the first record to the fourth record are read from the location whose record number is 0x18;

the first record read by the card is 708183908180229103A5E3120F2D2862091176AA2BD4E24D69E7EEF7B9195C91EA0088A ECFF47EDFA0BEEF7C391DF3B05F717DCC06FFC8EEFF90BA14212B8A52AD48B33277B 2E230D40B3E76DC59778926F1D8739E106CD741DE06A7423DFBA25E02F12E543D13D1B 471806526024981B7D26B4BF6E5558604CCC289F59E8A802F45FB3D9E67;

the second record read by the card is 70339F49039F37049F32010392248B643D1EAF2EA784AC205303C90E745EA2EFA5CBF02 CC47D47833BB7B27ECC6962385A4B8F0180; the third record read by the card is 70445F300202018C189F02069F03069F1A0295055F2A029A039F21039C019F37048D1A8A0 29F02069F03069F1A0295055F2A029A039F21039C019F37049F080200305F340101; the fourth record read by the card is 70099F7406454343313131;

In Embodiment 1, after receiving the application data, the terminal builds a static data list according to the application data, and the static data list is configured to verify a public key of the card which used for the static data authentication or the dynamic data authentication; the terminal executes an offline data authentication via public key technology, and the terminal decides the type of the offline authentication which is to be executed according to the received type of offline authentication which is supported by the card and the type of offline authentication which is supported by the terminal;

in the case that both of the card and the terminal support the static data authentication, the terminal verifies, via the public key technology, that key data in the card has not been changed since the card is issued, which specifically includes: the terminal retrieves a corresponding CA public key according to the CA public keys index, the CA public key is configured to verify an issuer certificate in the card, if the verification is successful, an issuer public key is obtained from the issuer certificate, the terminal verifies signed static application data via the issuer public key, if the verification is successful, the card and the terminal execute the static data authentication successfully;

Step 114, the card determines whether the card supports the dynamic data authentication, if yes, execute Step 115; otherwise, return an error response to the terminal, and return to Step 102;

Specifically, the card determines whether the card supports the dynamic data authentication according to the type of offline authentication supported by the card;

Step 115, the card parses the internal authentication command so as to obtain the second data, the second data is stored into the second preset memory;

Preferably, the card obtains the last four bytes of the internal authentication command so as to obtain the second data, in Embodiment 1, the internal authentication command is 008800000411223344, the second data obtained is 11223344;

Step 116, the card sets an executable bit of the dynamic data authentication, a first combinatorial data is obtained according to the second data and the first card data;

In Embodiment 1, obtaining the first combinatorial data according to the second data and the first card data specifically includes: start with 0x05, and 0x05 is composite with a hash algorithm identification (0x01), a length of the first card data (0x03), the first card data (0x020002), a preset filled character and the second data (0x11223344) so as to obtain the first combinatorial data, that is 050103020002BBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBB11223344;

Step 117, the card signs the first combinatorial data via the card private key so as to obtain dynamic signature data, a third credential is generated according to the dynamic signature data, the third credential is returned to the terminal, the second data is deleted, and Step 102 is returned to;

In Embodiment 1, after receiving the third credential, the terminal obtains the dynamic signature data, and then the terminal verifies the dynamic signature data via the public key of the card, if the verification is successful, the card and the terminal execute the dynamic data authentication successfully.

Step 118, the card parses the application cryptogram command, the type of the received application cryptogram command is determined according to a flag of the application cryptogram command, Step 119 is executed in the case that the application cryptogram command is the first application cryptogram command; Step 120 is executed in the case that the application cryptogram command is the second application cryptogram command;

In Embodiment 1, the card determining the type of application cryptogram command specifically is determining the flag of the application cryptogram command which is the third byte, the application cryptogram command is the first application cryptogram command in the case that the third byte is a first preset value; the application cryptogram command is the second application cryptogram command in the case that the third byte is a second preset value; preferably, the first preset value is 0x90, the second preset value is 0x50;

Step 119, the card executes the first application cryptogram command so as to generate a corresponding credential, the corresponding credential is returned to the terminal, and Step 102 is returned to.

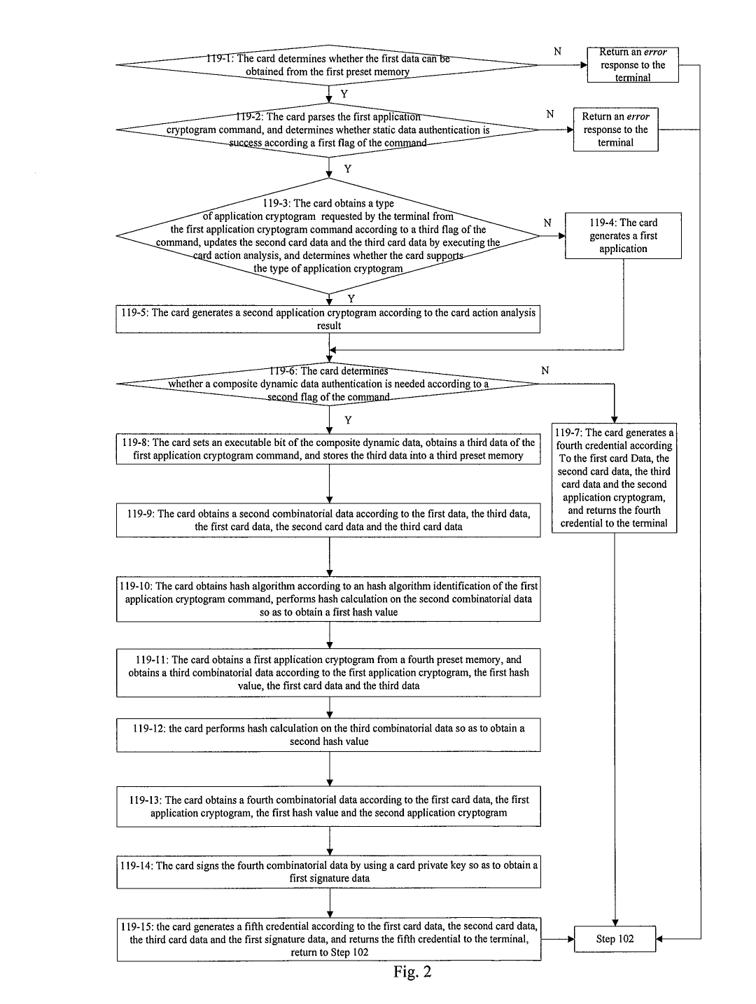

As shown in FIG. 2, Step 119 specifically includes:

Step 119-1, the card determines whether the first data can be obtained from the first preset memory, if yes, execute Step 119-2; otherwise, return an error response to the terminal, and return to Step 102; and

Step 119-2, the card parses the first application cryptogram command, and determines whether the static data is authenticated successfully according to a first flag in the command, if yes, execute Step 119-3; otherwise, return a response of refusing to operate to the terminal, and return to Step 102.

In Embodiment 1, the first application cryptogram command is 80AE9000200000000002000000000000000156000000000001560002291450340032E5DC2F.

The card determining whether the static data is authenticated successfully according to the first flag in the command specifically includes: determine whether a seventh bit of a twentieth byte of the command is a third preset value, if yes, the static data is authenticated successfully; otherwise, the static data is authenticated unsuccessfully; preferably, the third preset value is 0;

In Embodiment 1, the twentieth byte of the command is 00, the seventh bit is 0, the offline data is authenticated successfully;

Step 119-3, the card obtains a type of application cryptogram which is requested by the terminal from the first application cryptogram command according to a third flag of the command, updates the second card data and the third card data by executing the card action analysis, and determines whether the card supports the type of application cryptogram requested by the terminal, if yes, execute Step 119-4; otherwise, execute Step 119-5;

In Embodiment 1, the card obtaining the type of application cryptogram requested by the terminal from the first application cryptogram command according to the third flag of the command specifically includes: determine the first two bits of the third byte of the command, the type of application cryptogram requested by the terminal is refusing execution offline in the case that the first two bits of the third flag is a fifth preset value; the type of application cryptogram requested by the terminal is online executing in the case that the first two bits of the third flag is a sixth preset value; the type of application cryptogram requested by the terminal is approving execution offline in the case that the two bits of the third flag is a seventh preset value; preferably, the fifth preset value is 00, the sixth preset value is 01, and the seventh preset value is 10;

In Embodiment 1, in the case that the third byte of the command is 10, the type of application cryptogram requested by the terminal is approving execution offline;

In the present embodiment 1, determining whether the card supports the type of application cryptogram requested by the terminal specifically includes:

Step b1, the card executes the card action analysis, and checks whether there exists an unfinished online authorization in last operation, if yes, return an error response to the terminal, and return to Step 102; otherwise, execute Step b2;

Step b2, the card determines whether the authentication by issuer in last operation is unsuccessful, if yes, return an error response to the terminal, and return to Step 102; otherwise, execute Step b3;

Step b3, the card determines whether the offline data authentication is unsuccessful, if yes, return an error response to the terminal and return to Step 102; otherwise, execute Step b4; and

Step b4, the card executes a frequency check, and determines whether the operation times have reached an limit, if yes, return an error response to the terminal, and return to Step 102; otherwise, the card support the type of application cryptogram requested by the terminal.

In Embodiment 1, updating the second card date and the third card data by executing the card action analysis specifically includes:

Step d1, the card sets a first indicating bit of the second card data according to a result of online authentication at last time, and

in Embodiment 1, the first indicating bit of the second card data is 1 in the case that the result of online authentication at last operation is finished; while the first indicating bit of the second card data is 0 in the case that the result of online authentication at last operation is unfinished;

Step d2, the card sets a second indicating bit of the second card data and a first indicating bit of the third card data according to a result of authentication by issuer at last operation;

In Embodiment 1, the second indicating bit of the second card data is set as 0, and the first indicating bit of the third card data is set as 111 in the case that the result of authentication by issuer at last time is successful; the second indicating bit of the second card data is set as 1, and the first indicating bit of the third card data is set as 011 in the case that the result of authentication by issuer at last operation fails;

Step d3, the card sets a third indicating bit of the second card data according to a result of the static data authentication at last operation;

In Embodiment 1, the third indicating bit of the second card data is 0 in the case that the result of the static data authentication at last operation is successful; the third indicating bit of the second card data is 1 in the case that the result of the static data authentication at last operation fails;

Step d4, the card sets a fourth indicating bit of the second card data according to the result of the static data authentication at last operation;

In Embodiment 1, the fourth indicating bit of the second card data is set as 0 in the case that the result of the static data authentication in last operation is successful; the fourth indicating bit of the second card data is set as 1 in the case that the result of the static data authentication in last operation fails;

Step d5, the card sets a fifth indicating bit of the second card data according to a processing result of issuer's script in last online authorization operation;

In Embodiment 1, the fifth indicating bit of the second card data is set as 0 in the case that the processing result of the issuer's script in last online authorization operation is successful; the fifth indicating bit of the second card data is set as 1 in the case that the processing result of the issuer's script in last online authorization operation fails;

Step 119-4, the card generates a first application cryptogram according to the result of the card action analysis, and executes Step 119-6;

Specifically, generating the first application cryptogram specifically includes:

Step c1, the card obtains terminal data from the first application cryptogram command, and combines the terminal data, the second card data and the third card data so as to obtain data which generates an application cryptogram;

Specifically, the terminal data obtained by the card from the first application cryptogram command is the first five bytes of the first application plaintext command; the terminal data is jointed by the card with the second card data and the third card data in order so as to obtain data which generates an application cryptogram;

Step c2, the card pre-groups the data which generates the cryptogram, and determines whether the length of the last data block is a first preset length, if yes, execute Step c3; otherwise, execute Step c4;

Preferably, eight bytes is set as one group;

Step c3, the card adds a preset data block to the last data block, and then makes the data which is added with the preset data block as new data which generates application cryptogram, and execute Step d5;

Step c4, the card fills one byte of a first preset data behind the last data block, determines whether a length of the last data block which is filled with one byte of the first preset data is the first preset length, if yes, make the filled data block as new data which generates a cryptogram, and execute Step c5; otherwise, fill a second preset data behind the first preset data, and continue to fill data until the length of the filled data block is the preset length so as to obtain new data which generates an application cryptogram, and execute Step c5;

Step c5, the card obtains the application process key corresponding to the current application file, performs symmetric-key algorithm on the new data which generates the application cryptogram according to the application process key so as to generate a third application cryptogram;

In Embodiment 1, the first application cryptogram generated by the card by performing calculation on the new data which generates the application cryptogram according to the application process key is C5E89A185F6B0D1F;

Step 119-5, the card generates a second application cryptogram according to the result of the card action analysis, and executes Step 119-6;

Step 119-6, the card determines whether a composite and dynamic data authentication is needed according to the second flag of the command, if yes, execute Step 119-8; otherwise, execute Step 119-7;

Specifically, determine whether a fourth bit of the third byte is a fourth preset value, if yes, the composite and dynamic data authentication is needed; otherwise, the composite and dynamic data authentication is not needed; preferably, the fourth preset value is 1;

In Embodiment 1, the third byte of the command, parsed by the card, is 90 which is 10010000, in which the fourth bit is 1, thus, the composite and dynamic data authentication is needed.

Step 119-7, the card generates a fourth credential according to the first card data, the second card data, the third card data and the second application cryptogram, and returns the fourth credential to the terminal, return to Step 102;

Step 119-8, the card sets an executable bit of the composite and dynamic data authentication, and obtains the third data from the first application cryptogram command, subsequently, stores the third data into the third preset memory;

in which, the card parses the first application cryptogram command from the sixth byte so as to obtain a data field of the command, and the data field is the third data which is 0000000002000000000000000156000000000001560002291450340032E5DC2F;

Step 119-9: the card obtains a second combinatorial data according to the first data, the third data, the first card data, the second card data and the third card data;

Preferably, in the present embodiment, obtaining the second combinatorial data according to the first data, the third data, the first card data, the second card data and the third card data specifically includes: joint the first data with the third data, the second card data, the first card data and the third card data in order so as to obtain the second combinatorial data;

In Embodiment 1, the second combinatorial data obtained by jointing by the card the first data with the third data, the first card data, the second card data and the third card data in order is 015601000000000200015642616E6B204361726420546573742043656E7465000000000200000 0000000000156000000000001560002291450340032E5DC2F9F2701809F360200029F1013070 10103A40002010A0100000010009FFE6421;

Step 119-10, the card obtains a hash algorithm according to a hash algorithm identification of the first application cryptogram command, and performs hash calculation on the second combinatorial data so as to obtain a first hash value;

In Embodiment 1, the first hash value obtained by performing, by the card, hash calculation on the second combinatorial data is 947D4AD25925AD11F70B709354B4A3F1EF5888DF;

Step 119-11, the card obtains a first application cryptogram from the fourth preset memory, and obtains a third combinatorial data according to the first application cryptogram, the first hash value, the first card data and the third data;

Obtaining the third combinatorial data according to the first application cryptogram, the first hash value, the first card data and the third data specifically includes that: the card obtains the number of bytes of the second preset length of the third data, i.e. the last four bytes which is 0x32E5DC2F, and the card joints the third preset data which is 0x05 with the hash algorithm identification which is 0x01, the first card data, the first application cryptogram, the first hash value, the preset filled data and the obtained number of bytes of 0x32E5DC2F so as to obtain the third combinatorial data: 05012002000280C5E89A185F6B0D1F947D4AD25925AD11F70B709354B4A3F1EF5888DFB BBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBB32E5DC2F;

Step 119-12, the card performs hash calculation on the third combinatorial data so as to obtain a second hash value;

In Embodiment 1, the card performs hash calculation on the third combinatorial data so as to obtain the second hash value which is C092ADC4A768605DA13AF82A5EB681472A44C7DB;

Step 119-13, the card obtains a fourth combinatorial data according to the first card data, the first application cryptogram, the first hash value and the second application cryptogram;

In Embodiment 1, obtaining the fourth combinatorial data according to the first card data, the first application cryptogram, the first hash value and the second application cryptogram specifically includes: the card joints the fourth preset data (0x6a05), with the hash algorithm identification (0x01), the first card data, the first application cryptogram, the first hash value, the preset filled byte, the second hash value and a fifth preset data (0xBC) in order so as to obtain the fourth combinatorial data which is 6A05012002000280C5E89A185F6B0D1F947D4AD25925AD11F70B709354B4A3F1EF5888D FBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBBBBC092ADC4A768605DA13AF82A5EB681472A44C7DBBC;

Step 119-14, the card signs the fourth combinatorial data by using the card private key so as to obtain a first signature data;

In Embodiment 1, the card signs the fourth combinatorial data by using the card private key so as to obtain the first signature data which is 554B85DCEC2A61E9C54A3D67E0012E879DF4402D632F89F56481ABCEB1A4B51C011160 43734457240EF1C64AD5E1A32DA36B892E6F3242997DEEDB87350189F9A810DE98FBF2 B4275E64DB2FB03183A71348AA1785CBA2720E7726134E9874B2D759E365FAD6BCCEF B9591037C47B68F4FBA8927F697A191C1F112F3138A0B2D;

Step 119-15, the card generates a fifth credential according to the first card data, the second card data, the third card data and the first signature data, and returns the fifth credential to the terminal, return to Step 102;

In the present Embodiment 1, in accordance with the first card data, the second card data, the third card data and the first signature data, the card generates the fifth credential which is 7781A39F2701809F360200029F4B8180554B85DCEC2A61E9C54A3D67E0012E879DF4402 D632F89F56481ABCEB1A4B51C01116043734457240EF1C64AD5E1A32DA36B892E6F324 2997DEEDB87350189F9A810DE98FBF2B4275E64DB2FB03183A71348AA1785CBA2720E7 726134E9874B2D759E365FAD6BCCEFB9591037C47B68F4FBA8927F697A191C1F112F313 8A0B2D9F101307010103A40002010A0100000010009FFE6421.

Step 120, the card executes the second application cryptogram command so as to generate a corresponding credential, and returns the corresponding credential to the terminal, return to Step 102.

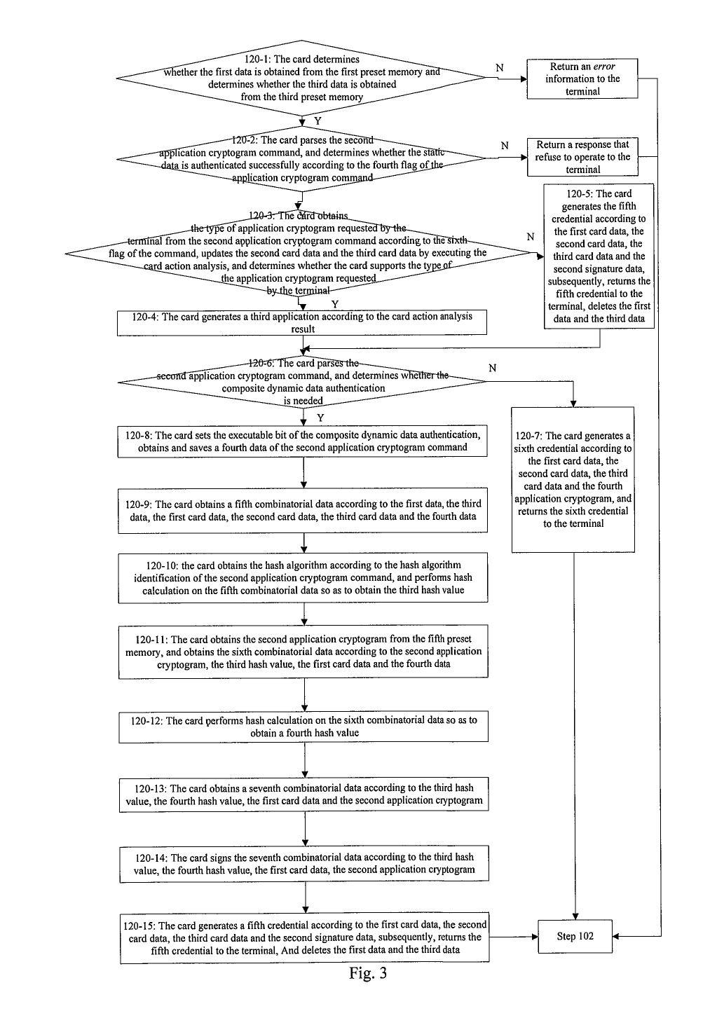

As shown in FIG. 3, Step 120 specifically includes:

Step 120-1, the card determines whether the first data is obtained from the first preset memory and determines whether the third data is obtained from the third preset memory, if yes, execute Step 120-2; otherwise, return an error response to the terminal, and return to Step 102;

Step 120-2, the card parses the second application cryptogram command, and determines whether the static data is authenticated successfully according to the fourth flag of the application cryptogram command, if yes, execute Step 120-3; otherwise, return a response of refusing to operate to the terminal, and return to Step 102.

In Embodiment 1, the second application cryptogram command is 80AE50002230300000000002000000000000000156000000000001560002291450340032E5DC 2F;

Determining whether the static data is authenticated successfully according to the fourth flag of the command specifically includes: determining whether a seventh bit of a twentieth byte of the command is 0, if yes, the offline data authentication is successful; otherwise, the offline data authentication fails;

In the present Embodiment 1, the twentieth byte of the command is 00, the seventh bit is 0, and the offline data authentication is successful;

Step 120-3, the card obtains the type of application cryptogram requested by the terminal from the second application cryptogram command according to the sixth flag of the command, updates the second card data and the third card data by executing the card action analysis, and determines whether the card supports the type of the application cryptogram requested by the terminal, if yes, execute Step 120-4; otherwise, execute Step 120-5;

the card obtaining the type of application cryptogram requested by the terminal according to the sixth flag of the command specifically includes: determine the first two bits of the third byte of the command, if the first two bits are 00, the type of application cryptogram requested by the terminal is refusing execution offline; the type of application cryptogram requested by the terminal is online executing in the case that the first two bits are 01; the type of application cryptogram requested by the terminal is approving execution offline in the case that the first two bits are 10;

In the present Embodiment 1, the first two bits of the third byte of the command are 01, thus, the type of application cryptogram requested by the terminal is approving execution offline;

in Embodiment 1, updating the second card data and the third card data by executing the card action analysis specifically comprises:

Step g1, the card checks the online authorization operation of last time to obtain a result, and sets the first indicating bit of the second card data according to the result;

in the present Embodiment 1, the first indicating bit of the second card data is 1 in the case that the online authorization operation of last time is finished; the first indicating bit is 0 in the case that the online authorization operation of last time if unfinished;

Step g2, the card detects issuer's authentication of last time to obtain a result, and sets the second indicating bit of the second card data and the first indicating bit of the third card data according to the result;

in Embodiment 1, the second indicating bit of the second card data is 0 in the case that the result of issuer's authentication of last time is success, and the first indicating of the third card data is set as 111; the second indicating bit of the second card data is set as 1 in the case that the result of issuer's authentication of last time is failure, and the first indicating bit of the third card is set as 011;

Step g3, the card detects the static data authentication of last operation to obtain a result, and sets the third indicating bit of the second card data according to the result;

in the present Embodiment 1, the third indicating bit of the second card data is set as 0 in the case that the result of static data authentication of last operation is success; the third indicating bit of the second card data is set as 1 in the case that the result is failure;

Step g4, the card detects the dynamic data authentication of last operation to obtain a result, and sets the fourth indicating bit of the second card data according to the result;

in Embodiment 1, the fourth indicating bit of the second card is set as 0 in the case that the result of dynamic data authentication of last operation is success; the fourth indicating bit of the second card data is set as 1 in the case that the result of dynamic data authentication of last operation is failure;

Step g5, the card detects the issuer's script processing of last online authorization operation to obtain a result, and sets the fifth indicating bit of the second card data according to the result;

in Embodiment 1, the fifth indicating bit is set as 0 in the case that the result of issuer's script processing of last online authorization operation is success; the fifth indicating bit of the second card data is set as 1 in the case that the result of issuer's script processing of last online authorization operation is failure;

Step 120-4, the card generates the third application cryptogram according to the result of card action analysis, and executes Step 120-6.

Generating the third application cryptogram specifically includes:

Step d1, the card obtains the terminal data from the second application cryptogram command, and combines the terminal data, the second card data and the third card data so as to obtain data which generates cryptogram;

Step d2, the card pre-groups the data which generates cryptogram, and determines whether the length of the last data block after pre-grouping is the first preset length, if yes, execute Step d3; otherwise, execute Step d4;

Step d3, the card adds the preset data block to the last data block, and makes the added data as the new data which generates cryptogram, executes Step d5;

Step d4, the card fills one byte of the first preset data behind the last data block, and determines whether the length of the filled data block is the first preset length, if yes, make the filled data as the new data which generates cryptogram, and execute Step d5; otherwise, fill the second preset data behind the first preset data, continue to fill until the length of the last data block is the preset length, the new data which generates cryptogram is obtained, and Step d5 is executed; and

Step d5, the card obtains the application process key corresponding to the current application file, performs symmetric-key algorithm on the new data which generates application cryptogram according to the application process key so as to generate the third application cryptogram;

Step 120-5, the card generates the fourth application cryptogram according to the result of card action analysis, and executes Step 120-6;

Step 120-6, the card parses the second application cryptogram command, and determines whether the composite and dynamic data authentication is needed, if yes, execute Step 120-8; otherwise, execute Step 120-7;

In Embodiment 1, the card determining whether the composite and dynamic data authentication is needed according to the fifth flag of the command specifically includes: determining whether the fourth bit of the third byte of the command is 1, if yes, the composite and dynamic data authentication is needed; otherwise, the composite and dynamic data authentication is not needed;

in Embodiment 1, the third byte of the command parsed by the card is 50, i.e. 01010000, the fourth bit of which is 1, thus, the composite and dynamic data authentication is needed;

Step 120-7, the card generates the sixth credential according to the first card data, the second card data, the third card data and the fourth application cryptogram, and returns the sixth credential to the terminal, and returns to Step 102;

Step 120-8, the card sets the executable bit of the composite and dynamic data authentication, obtains and saves the fourth data of the second application cryptogram command;

in Embodiment 1, starting from the sixth byte of the second application cryptogram command, the card parses the command so as to obtain the data field of the command, the data field is the fourth data which is 30300000000002000000000000000156000000000001560002291450340032E5DC2F;

Step 120-9, the card obtains the fifth combinatorial data according to the first data, the third data, the first card data, the second card data, the third card data and the fourth data;

in Embodiment 1, the card obtaining the fifth combinatorial data according to the first data, the third data, the first card data, the second card data, the third card data and the fourth data specifically includes: the first data is jointed with the third data, the fourth data, the second card data, the first card data and the third card data in order so as to obtain the fifth combinatorial data which is 015601000000000200015642616E6B204361726420546573742043656E7465000000000200000 0000000000156000000000001560002291450340032E5DC2F303000000000020000000000000 00156000000000001560002291450340032E5DC2F9F2701409F360200029F101307010103640 402010A0100000010009FFE6421;

Step 120-10, the card obtains the hash algorithm according to the hash algorithm identification of the second application cryptogram command, and performs hash calculation on the fifth combinatorial data so as to obtain the third hash value;

in Embodiment 1, the third hash value obtained by the card performing hash calculation on the fifth combinatorial data is 30ADB2EC3859891F04668CC6C28629AFD7205CCE;

Step 120-11, the card obtains the second application cryptogram from the fifth preset memory, and obtains the sixth combinatorial data according to the second application cryptogram, the third hash value, the first card data and the fourth data;

in Embodiment 1, obtaining the sixth combinatorial data according to the second application cryptogram, the third hash value, the first card data and the fourth data specifically includes that: the card obtains the number of bytes of the second preset length from the fourth data, which is the last four bytes, i.e. 0x32E5DC2F, the third preset data (0x05) is jointed with the hash algorithm identification (0x01), the first card data, the second application cryptogram, the third hash value, the preset fill byte and the obtained number of bytes (0x32E5DC2F) in order so as to obtain the sixth combinatorial data which is 0501200200024001B3C9B06283C08030ADB2EC3859891F04668CC6C28629AFD7205CCEB BBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBB32E5DC2F;

Step 120-12, the card performs hash calculation on the sixth combinatorial data so as to obtain the fourth hash value;

in Embodiment 1, the fourth hash value obtained by the card performing hash calculation on the sixth combinatorial data is 808A60BD056FC118BAF6723538B154CDDD2DEFB8;

Step 120-13, the card obtains the seventh combinatorial data according to the third hash value, the fourth hash value, the first card data and the second application cryptogram;

in the present Embodiment 1, obtaining the seventh combinatorial data according to the third hash value, the fourth hash value, the first card data, the second application cryptogram specifically includes that: the card joints the fourth preset data (0x6a05) with the hash algorithm identification (0x01), the first card data, the second application cryptogram, the third hash value, the preset fill byte and the fifth preset data (0xBC) in order so as to obtain the seventh combinatorial data which is 6A0501200200024001B3C9B06283C08030ADB2EC3859891F04668CC6C28629AFD7205CC EBBBBBBBBBBBBBBBBBBBBBBBBBBBBBBBBBBBBBBBBBBBBBBBBBBBBBBBBB BBBBBBBBBBBBBBBBBBBBBBBBBBBBBBBBBBBBBBBBBBBBBBBBBBBBBBBBBB BBBBBBBBBBBBBBBBBBBBBBBBBBB808A60BD056FC118BAF6723538B154CDDD2D EFB8BC;

Step 120-14, the card signs the seventh combinatorial data by using the card private key so as to obtain the second signature data;

in the present Embodiment 1, the second signature data obtained by the card signing the seventh combination data via the card private key is 64410712FDDF7EE1031780D1E673006611AAB2AFDD140CD3DC6DDDAE19059DF2E5FD 2935E51CC4CE8F25F204ACE1AF712E40497FD7C4FA75B4A34DC66A3BEDA20C4E1277 BD493E6C36D54D2737716CF6AE970EC9FBAAEE985F903BCDFD990A2DCDEC439E9DE 288A824438BAC74565A946C4A6959D492D3D5DC3751894AA6F06A;

Step 120-15, the card generates the fifth credential according to the first card data, the second card data, the third card data and the second signature data, subsequently, returns the fifth credential to the terminal, deletes the first data and the third data, and returns to Step 102;

in the present Embodiment 1, the fifth credential generated according to the second application cryptogram, the first card data, the second card data, the third card data and the second signature data is: 7781A39F2701409F360200029F4B818064410712FDDF7EE1031780D1E673006611AAB2AF DD140CD3DC6DDDAE19059DF2E5FD2935E51CC4CE8F25F204ACE1AF712E40497FD7C 4FA75B4A34DC66A3BEDA20C4E1277BD493E6C36D54D2737716CF6AE970EC9FBAAEE 985F903BCDFD990A2DCDEC439E9DE288A824438BAC74565A946C4A6959D492D3D5DC 3751894AA6F06A9F101307010103640402010A0100000010009FFE6421.

Above description is only to illustrate the preferred embodiments, not to limit the present invention. Any modification and equivalent substitute made by those skilled in the art in the scope of the technical solution of the present disclosure should fall into the scope of protection of the present disclosure.

1. A method for generating a credential of offline authentication by a smart card, wherein the method comprises:
Step 101, powering on a smart card and initializing the card;
Step 102, waiting, by the card, for receiving a command sent from a terminal, and determining a type of the command;
in the case that the command is a command for getting processing options, parsing the command for getting processing options so as to obtain a first data, updating a first card data, and initializing a second card data and a third card data, generating a second credential according to a type of offline authentication which is supported by the card, and then returning the second credential to the terminal, and returning to Step 102;
in the case that the command is an internal authentication command, determining whether the internal authentication command supports a dynamic data authentication, if yes, parsing the internal authentication command so as to obtain a second data, obtaining a first combinatorial data according to the second data and the first card data, signing the first combinatorial data by using a card private key so as to obtain a dynamic signature data, generating a third credential according to the dynamic signature data, and returning the third credential to the terminal, and returning to Step 102; otherwise, returning an error response to the terminal, and returning to Step 102;
in the case that the command is an application cryptogram command, determining a type of the application cryptogram command, executing Step 103 if the application cryptogram command is the first application cryptogram command; while executing Step 108 if the application cryptogram command is the second application cryptogram command;
Step 103, determining, by the card, whether the first data can be obtained, if yes, executing Step 104; otherwise, returning an error response to the terminal, and returning to Step 102;
Step 104, obtaining, by the card, a type of application cryptogram which is requested by the terminal from the first application cryptogram command, updating the second card data and the third card data by executing a card action analysis, subsequently, determining whether the card meets the type of application cryptogram which is requested by the terminal, if yes, generating a first application cryptogram according to a result of the card action analysis, and executing Step 105; otherwise, generating a second application cryptogram according to the result of the card action analysis, and executing Step 105;
Step 105, parsing, by the card, the first application cryptogram command, determining whether a composite and dynamic data authentication is needed, if yes, executing Step 106; otherwise, generating a fourth credential according to the first card data, the second card data, the third card data and the second application cryptogram, and returning the fourth credential to the terminal, returning to Step 102;
Step 106, obtaining, by the card, a third data from the first application cryptogram command, obtaining a fourth combinatorial data according to the first data, the first card data, the second card data, the third card data, the first application cryptogram and the third data, signing the fourth combinatorial data by a card private key so as to obtain a first signature data, subsequently, generating a fifth credential according to the first card data, the second card data, the third card data and the first signature data, and returning the fifth credential to the terminal, then returning to Step 102;
Step 107, determining, by the card, whether the first data and the third data can be obtained, if yes, executing Step 108; otherwise, returning an error response to the terminal, and returning to Step 102;
Step 108, obtaining, by the card, the type of application cryptogram which is requested by the terminal from the second application cryptogram command, updating the second card data and the third card data by executing the card action analysis, and determining whether the card meets the type of application cryptogram which is requested by the terminal, if yes, generating a third application cryptogram according to the result of the card acting analysis, and executing Step 109; otherwise, generating a fourth application cryptogram according to the result of the card action analysis, and executing Step 109;
Step 109, parsing, by the card, the second application cryptogram command, determining whether the composite and dynamic data authentication is needed, if yes, executing Step 110; otherwise, generating a sixth credential according to the first card data, the second card data, the third card data and the fourth application cryptogram, and returning the sixth credential to the terminal, and returning to Step 102; and
Step 110, obtaining, by the card, a fourth data from the second application cryptogram command, obtaining a seventh combinatorial data according to the first data, the first card data, the second card data, the third card data, the third application cryptogram, the third data and the fourth data; signing the seventh combinatorial data by the card private key so as to obtain a second signature data, and then generating a seventh credential according to the first card data, the second card data, the third card data and the second signature data, returning the seventh credential to the terminal, and returning to Step 102.

2. The method as claimed in claim 1, wherein Step 102 further comprises: when the received command is a selecting application command, executing the following step:
Step 102-1, parsing, by the card, the selecting application command, determining a selection mode in the selecting application command according to a data field of the selecting application command, executing Step 102-2 in the case that the selection mode is a first selection mode; while executing Step 102-3 in the case that the selection mode is a second selection mode;
Step 102-2, obtaining, by the card, a status of the card, determining whether the card is locked, if yes, returning a response to the terminal that the card is locked, and returning to Step 102; otherwise, executing Step 102-3;
Step 102-3, obtaining, by the card, a first application information from the selecting application command, retrieving the card according to the first application information, subsequently, determining whether an application file which corresponds to the first application information can be found, if yes, and executing Step 102-4; otherwise, returning a response to the terminal that the first application information is not supportive, and returning to Step 102;
Step 102-4, determining, by the card, whether the first application information is locked, if yes, returning a response that the first application information is locked to the terminal, and returning to Step 102; otherwise, making the application file corresponding to the first application information as a current application file, and executing Step 102-8;
Step 102-5, obtaining, by the card, the status of the card, and determining whether the card is locked, if yes, returning a response that the card is locked to the terminal, and returning to Step 102; otherwise, executing Step 102-6;
Step 102-6, obtaining, by the card, a second application information from the selecting application command, retrieving the card according to the second application information, and determining whether the application information corresponding to the second application information can be found, if yes, executing Step 102-7; otherwise, returning a response that the second application information is not supportive to the terminal, and returning to Step 102;
Step 102-7, determining, by the card, whether the second application information is locked, if yes, returning a response that the second application information is locked to the terminal, and returning to Step 102; otherwise, making the application file corresponding to the second application information as the current application file, and returning to Step 102-8; and
Step 102-8, obtaining, by the card, a first list from the current application file, generating a first credential according to the first list, and returning the first credential to the terminal, and returning to Step 102.

3. The method as claimed in claim 1, wherein, in the case that the command is a command for getting processing options, Step 102 specifically comprises:
Step a1, determining, by the card, whether the first data can be obtained by parsing the command for getting processing options, if yes, saving the first data, and executing Step a2; otherwise, returning an error information to the terminal, and returning to Step 102;
Step a2, updating, by the card, the first card data, checking whether the first card data reaches a threshold, if yes, executing Step a3; otherwise, executing Step a4;
Step a3, locking the card, generating the response that the card is locked, and returning the response to the terminal, then returning to Step 102;
Step a4, initializing, by the card, the second card data and the third card data; and
Step a5, obtaining, by the card, file information which is to be read from the card, and then obtaining a first information according to the file information, generating the second credential according to the first information and the type of offline authentication which is supported by the card, and returning the second credential to the terminal, and returning to Step 102;
in the case that the received command is a read record command, Step 102 further comprises:
Step f1, parsing, by the card, the read record command so as to obtain the first information; and
Step f2, reading, by the card, application data from the card according to the first information, returning the application data to the terminal, and returning to Step 102.

4. The method as claimed in claim 1, wherein, in the case that the command is an internal authentication command and the determination result is yes, Step 102 further comprises: setting, by the card, an executable bit of the dynamic data authentication.

5. The method as claimed in claim 1, wherein, determining a type of the application cryptogram command in Step 102 specifically comprises: parsing, by the card, the application cryptogram command, determining the type of application cryptogram command according to a flag in the application cryptogram command, the application cryptogram command is the first application cryptogram command in the case that the flag in the application cryptogram command is a first preset value; while the application cryptogram command is the second application cryptogram command in the case that the flag in the application cryptogram command is a second preset value.

6. The method as claimed in claim 1, wherein, between Step 103 and Step 104, the method further comprises: determining, by the card, whether static data is authenticated successfully according to a first flag of the first application cryptogram command, if yes, executing Step 104; otherwise, returning a response to the terminal that refuse to operate, and returning to Step 102;
in which, determining whether the static data is authenticated successfully specifically comprises: determining whether the first flag is a third preset value, if yes, the static data is authenticated successfully; otherwise, the static data is authenticated unsuccessfully, and returning the response that refuse to operate.

7. The method as claimed in claim 1, wherein, determining whether the composite and dynamic data authentication is needed in Step 105 specifically comprises: determining, by the card, whether a second flag of the first application cryptogram command is a fourth preset value, if yes, executing the composite and dynamic data authentication; otherwise, the composite and dynamic data authentication is not needed.

8. The method as claimed in claim 1, obtaining a type of application cryptogram which is requested by the terminal from the first application cryptogram command in Step 104 specifically comprises: obtaining, by the card, the type of application cryptogram which is requested by the terminal according to a third flag of the first application cryptogram command, the type of application cryptogram which is requested by the terminal is refusing execution offline in the case that the third flag is a fifth preset value; the type of application cryptogram requested by the terminal is online executing in the case that the third flag is a sixth preset value; the type of application cryptogram requested by the terminal is approving execution offline in the case that the third flag is a seventh preset value.

9. The method as claimed in claim 1, wherein, generating the first application cryptogram specifically comprises:
Step b1, obtaining, by the card, terminal data from the first application cryptogram command, and combining the terminal data, the second card data and the third card data so as to obtain data which generates the application cryptogram;
Step b2, grouping in a preset way, by the card, the data which generates the application cryptogram, determining whether a length of the last data block after the data is grouped is a first preset length, if yes, executing Step b3; otherwise, executing Step b4;
Step b3, adding, by the card, a preset data block to the last data block, making data which is obtained by adding the preset data block to the last data block as new data which generates the application cryptogram, and executing Step b5;
Step b4, filling, by the card, one byte of a first preset data behind the last data block, determining whether a length of the data block obtained after one byte of the first preset data is filled behind the last data block is the first preset length, if yes, making the data obtained after the last data block is filled as new data which generates the application cryptogram, and executing Step b5; otherwise, filling a second preset data behind the first preset data, continuing the same operation until the length of the last data block is the preset length, so as to obtain new data which generates the application cryptogram, and executing Step b5; and
Step b5, obtaining, by the card, an application process key corresponding to the current application file, performing a symmetric-key algorithm on the new data which generates the application cryptogram so as to generate a first application cryptogram.

10. The method as claimed in claim 1, wherein, in Step 106, obtaining the fourth combinatorial data according to the first data, the first card data, the second card data, the third card data, the first application cryptogram and the third data specifically comprises:
Step 106-1, obtaining, by the card, a second combinatorial data by jointing the first data, the third data, the second card data, the first card data, and the third card data orderly;
Step 106-2, obtaining, by the card, hash algorithm according to a hash algorithm identification of the first application cryptogram command, and operating hash calculation on the second combinatorial data so as to obtain a first hash value;
Step 106-3, obtaining, by the card, the number of bytes of the second preset length from the third data, obtaining a third combinatorial data by jointing the third preset data, the hash algorithm identification, the first card data, the first application cryptogram, the first hash value, a preset filled byte and the obtained number of bytes orderly;
Step 106-4, performing, by the card data, hash calculation on the third combinatorial data so as to obtain a second hash value; and
Step 106-5, obtaining, by the card, a fourth combinatorial data by jointing a fourth preset data, the hash algorithm identification, the first card data, the first application cryptogram, the first hash value, a preset filled byte, the second hash value and a fifth preset data orderly.

11. The method as claimed in claim 1, wherein, between Step 107 and Step 108, the method further comprises: determining, by the card, whether the static data is authenticated successfully according to a fourth flag of the second application cryptogram command, the static data is authenticated successfully in the case that the fourth flag is 0, and continuing; the static data is authenticated unsuccessfully in the case that the fourth flag is 1, returning a response to the terminal that refusing to operate, and returning to Step 102.

12. The method as claimed in claim 1, wherein, when the composite and dynamic data authentication is needed, Step 109 further comprises: setting, by the card, the executable bit of the composite and dynamic data authentication.

13. The method as claimed in claim 1, wherein, determining whether the composite and dynamic data authentication is needed in Step 109 specifically comprises: determining, by the card, whether the composite and dynamic data authentication is needed according to a fifth flag of the second application cryptogram command, the composite and dynamic data authentication is needed in the case that the fifth flag is 1; while the composite and dynamic data authentication is not needed in the case that the fifth flag is 0.

14. The method as claimed in claim 1, wherein, obtaining the type of application cryptogram requested by the terminal from the second application cryptogram command in Step 108 specifically comprises: obtaining, by the card, the type of application cryptogram requested by the terminal according to the sixth flag of the second application cryptogram command, the type of application cryptogram requested by the terminal is refusing execution offline in the case that the fifth flag is 00; the type of application cryptogram requested by the terminal is executing online in the case that the fifth flag is 01; and the type of application cryptogram requested by the terminal is approving execution offline in the case that the fifth flag is 10.

15. The method as claimed in claim 1, wherein, determining whether the card supports the type of application cryptogram requested by the terminal specifically comprises:
Step c1, executing, by the card, a card action analysis, and detecting whether there exists an online authorization operation which is unfinished last time, if yes, returning an error response to the terminal, returning to Step 102; otherwise, executing Step c2;
Step c2, determining, by the card, whether an authentication by issuer in last operation fails, if yes, returning an error response to the terminal, and returning to Step 102; otherwise, executing Step c3;
Step c3, determining, by the card, whether an offline data authentication in last operation fails, if yes, returning an error response to the terminal, and returning to Step 102; otherwise, executing Step c4; and
Step c4, executing, by the card, a frequency checking, determining whether times of operation reach a limit, if yes, returning an error response to the terminal, and returning to Step 102; otherwise, supporting the type of application cryptogram requested by the terminal.

16. The method as claimed in claim 1, wherein, generating the third application cryptogram specifically comprises:
Step d1, obtaining, by the card, terminal data from the second application cryptogram command, combining the terminal data, the second card data and the third card data so as to obtain data which generates the cryptogram;
Step d2, pre-grouping, by the card, the data which generates the cryptogram, and determining whether the length of the last data block is the first preset length, if yes, executing Step d3; otherwise, executing Step d4;
Step d3, adding, by the card, the preset data block to the last data block, and then making the data obtained by adding the preset data block to the last data block as new data which generates a cryptogram, and executing Step d5;
Step d4, filling, by the card, one byte of a first preset data of behind the last data block, determining whether a length of the data block obtained by filling one byte of the first preset data behind the last block is the first preset length, if yes, making the filled data as new data which generates the cryptogram, and executing Step d5; otherwise, filling a second preset data behind the first preset data, and continuing the operation until the length of the last data block obtained after the data is filled is with the preset length so as to obtain new data which generates the cryptogram, and executing Step d5; and
Step d5, obtaining, by the card, the application process key corresponding to the current application file, performing symmetric-key algorithm on the new data which generates the application cryptogram according to the application process key, so as to generate a third application cryptogram.

17. The method as claimed in claim 1, wherein, in Step 110, obtaining the seventh combinatorial data according to the first data, the first card data, the second card data, the third card data, the second application cryptogram, the third data and the fourth data specifically comprises:
Step 110-1, obtaining, by the card, a fifth combinatorial data by jointing orderly the first data, the third data, the fourth data, the second card data, the first card data and the third card data;
Step 110-2, obtaining, by the card, a hash algorithm according to a hash algorithm identification of the second application cryptogram command, performing hash calculation on the fifth combinatorial data so as to obtain a third hash value;
Step 110-3, obtaining, by the card, the number of bytes of the second preset length from the fourth data, jointing orderly the third preset data, the hash algorithm identification, the first card data, the second application cryptogram, the third hash value, the preset filled byte and the obtained number of bytes so as to obtain a sixth combinatorial data;
Step 110-4, performing, by the card, hash calculation on the sixth combinatorial data so as to obtain a fourth hash value; and
Step 110-5, obtaining, by the card, a seventh combinatorial data by jointing orderly the fourth preset data, the hash algorithm identification, the first card data, the second application cryptogram, the third hash value, the preset filled byte and the fifth preset data.

18. The method as claimed in claim 1, wherein, updating the second card data and the third card data by executing the card action analysis specifically comprises:
Step e1, setting, by the card, a first indicating bit of the second card data according to a result obtained by detecting the online authorization in the last operation;
Step e2, setting, by the card, a second indicating bit of the second card data and a first indicating bit of the third card data according to a result obtained by detecting the authentication of issuer in the last operation;
Step e3, setting, by the card, a third indicating bit of the second card data according to a result obtained by detecting the static data authentication in the last operation;
Step e4, setting, by the card, a fourth indicating bit of the second card data according to a result obtained by detecting the dynamic data authentication in the last operation;
Step e5, setting, by the card, a fifth indicating bit of the second card data according to a result obtained by detecting process of issuer's script in the last online authorization operation.

19. The method as claimed in claim 1, wherein,
in Step 102, obtaining the first data further comprises: saving the first data;
in Step 102, obtaining the second data further comprises: saving the second data;
in Step 102, returning the third credential to the terminal further comprises: deleting the second data;
in Step 106, obtaining the third data from the first application cryptogram command further comprises: saving the third data;
in Step 110, obtaining the fourth data from the second application cryptogram command further comprises: saving the fourth data; and
in Step 110, returning the seventh credential to the terminal further comprises: deleting the first data, the third data and the fourth data.
